(19) United States
(12) Patent Application Publication
(10) Pub. No.: US 2025/0217411 A1
(43) Pub. Date: Jul. 3, 2025

(54) METHOD AND ELECTRONIC DEVICE FOR IMAGE SEARCH

(71) Applicant: ASUSTeK COMPUTER INC., Taipei City (TW)

(72) Inventors: Shih-Wei Su, Taipei City (TW); Szu-Wei Chang, Taipei City (TW); Tao-Jung Lin, Taipei City (TW)

(73) Assignee: ASUSTeK COMPUTER INC., Taipei City (TW)

(21) Appl. No.: 18/937,038

(22) Filed: Nov. 5, 2024

(30) Foreign Application Priority Data
Dec. 28, 2023 (TW) 112151256

(51) Int. Cl. G06F 16/56; G06F 16/55; G06F 16/587

(52) U.S. Cl. CPC G06F 16/56; G06F 16/55; G06F 16/587

(57) ABSTRACT

Disclosed are a method and an electronic device for image search. The method includes: obtaining a search string provided to search for images; determining whether the search string matches one of the classification tags, and while the search string matches one of the classification tags, to-be-searched images corresponding to the one of the classification tags are presented in a user interface; while the search string does not match the classification tags, obtaining a second comparison vector according to the search string based on a multi-modal artificial intelligence (AI) model, determining a correlation degree between the second comparison vector and the first comparison vector corresponding to the to-be-searched images to generate a search result; and, identifying whether the search string has a second location information, so that the search results generated based on the search results and the second location information are presented in the user interface.

### CROSS-REFERENCE TO RELATED APPLICATION

This application claims the priority benefit of Taiwan application no. 112151256, filed on Dec. 28, 2023. The entirety of the above-mentioned patent application is hereby incorporated by reference herein and made a part of this specification.

### BACKGROUND

### Field of the Disclosure

The present disclosure relates to a method and an electronic device for image search.

### Description of Related Art

Users often use the image-capturing function of a consumer electronic device (such as smart phones) to acquire a large number of photos and videos. Alternatively, when browsing social media, users may store images of interest in storage media (e.g., smartphones, network hard drives) and the number of stored images is accumulated.

However, there is only download time or the time of capturing images is marked in these images or photos, making it difficult for users to easily find the images or photos they want. For example, normally users may only search for the desired images or photos one by one according to time or through browsing manually.

### SUMMARY OF THE DISCLOSURE

The present disclosure provides a method for image search. The method includes: obtaining a search string, wherein the search string is provided to search for one or more of a plurality of to-be-searched images, each to-be-searched image corresponds to a first comparison vector, and at least one classification tag and first location information respectively correspond to a part of the to-be-searched images; determining whether the search string matches one of the at least one classification tag, and while the search string matches one of the at least one classification tag, generating a first search result based on the to-be-searched image corresponding to one of the at least one classification tag, and presenting the first search result in a user interface; while the search string does not match one of the at least one classification tag, obtaining a second comparison vector corresponding to the search string according to the search string based on a multi-modal artificial intelligence (AI) model, determining a correlation degree between the second comparison vector and the at least one first comparison vector corresponding to the to-be-searched image to generate a second search result, wherein the second search result includes a part of the to-be-searched images; and identifying whether the search string has a second location information, so that a third search result is generated based on the second search result and the second location information, and the third search result is presented in the user interface.

The present disclosure further provides an electronic device, which includes a processor, a storage device and a display device. The storage device is provided to store a plurality of to-be-searched images. The display device includes a user interface. The processor obtains a search string, wherein the search string is provided to search for one or more of a plurality of to-be-searched images, each to-be-searched image corresponds to the first comparison vector, and at least one classification tag and the first location information respectively correspond to a part of the to-be-searched images. The processor determines whether the search string matches one of the at least one classification tag, and when the search string matches one of the at least one classification tag, generates a first search result based on the to-be-searched image corresponding to one of the at least one classification tag, and presents the first search result in the user interface. While the search string does not match one of the at least one classification tag, the processor obtains a second comparison vector corresponding to the search string according to the search string based on a multi-modal artificial intelligence (AI) model, determines a correlation degree between the second comparison vector and the at least one first comparison vector corresponding to the to-be-searched image to generate a second search result, wherein the second search result includes a part of the to-be-searched images. The processor identifies whether the search string has a second location information, so that a third search result is generated based on the second search result and the second location information, and the third search result is presented in the user interface.

Based on the above, the method and electronic device for image search described in the embodiments of the present disclosure first generate one or more classification tags, comparison tags and location information corresponding to each to-be-searched image for a large number of to-be-searched images through a classification artificial intelligence (AI) model, a multi-modal AI model and a location provider. Then, it is determined based on the search string input by the user whether the classification tag is one of the classification tags in the category database. If the search string is one of the classification tags, the to-be-searched image corresponding to the classification tag will be used as the search result and presented in the user interface. In contrast, if the search string does not completely match one of the classification tags, the embodiment uses a multi-modal AI model to compare the correlation degree between the comparison vector of the search string and the comparison vector corresponding to each to-be-searched image, and uses the natural language recognition model to analyze the location information in the search string to use the to-be-searched image that is highly relevant and located in the corresponding location information as a search result and present the to-be-searched image in the user interface. Through the method and electronic device in the embodiments of the present disclosure, users may more conveniently find the desired images or photos among a large number of images.

### BRIEF DESCRIPTION OF THE DRAWINGS

FIG. 1 is a schematic diagram of an electronic device 100 according to an embodiment of the present disclosure.

FIG. 2 is a first flowchart of a method for image search according to an embodiment of the present disclosure.

FIG. 3 is a schematic diagram of a plurality of AI models and corresponding databases in FIG. 2.

FIG. 4 is a second flowchart of a method for image search according to an embodiment of the present disclosure.

FIG. 5 is a schematic diagram of a multi-modal artificial intelligence (AI) model for images and text according to an embodiment of the present disclosure.

### DESCRIPTION OF EMBODIMENTS

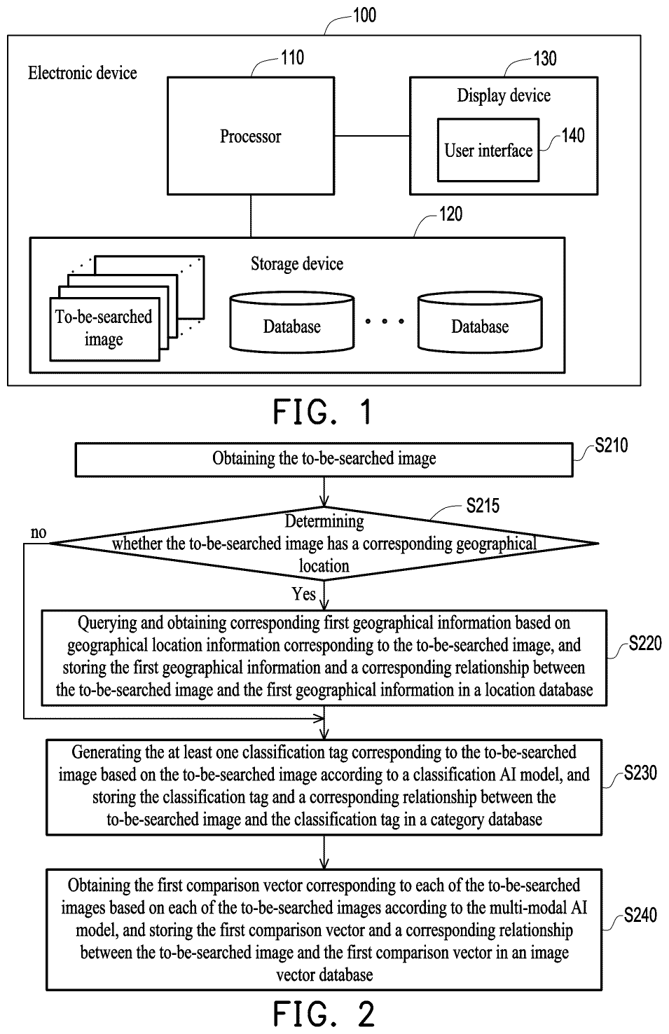

FIG. 1 is a schematic diagram of an electronic device 100 according to an embodiment of the present disclosure. As shown in FIG. 1, the electronic device 100 may be a consumer electronic device, such as a smartphone, a tablet computer, a notebook computer, etc. with an image-capturing function. The electronic device 100 may also be adaptable for devices that store a large number of images, such as network attached storage (NAS), servers, etc.

The electronic device 100 includes a processor 110, a storage device 120 and a display device 130. The processor 110 may be a general-purpose processor, a digital signal processor (DSP), an application specific integrated circuit (ASIC), a field programmable gate array (FPGA) or other programmable logic device, a transistor logic integrated circuit . . . and so on. The display device 130 may be a display panel on the electronic device 100, and the user interface 140 used in this embodiment may be displayed on the display panel to display search results. In some embodiments consistent with the present disclosure, the display device 130 may be disposed outside the electronic device 100, and the display device 130 and the processor 110 may communicate with each other through corresponding communication technologies (such as wired communication, wireless communication), so as to present the search result on the display device 130. The storage device 120 may be a non-volatile storage device, such as a hard disk, a flash memory, etc. The storage device 120 of this embodiment stores a large number of to-be-searched images and various databases required by this embodiment.

The to-be-searched image in this embodiment may be a photo obtained by the user through the image-capturing function of the electronic device, an image obtained from a social network or other sources, a screenshot taken from the display device of the electronic device, images at specific time points in the video . . . etc. Normally, because the number of “to-be-searched images” mentioned above is large, the user may only mark some images (for example, mark the icon as “my favorite”) or specify their categories, and some electronic devices 100 will match the photo with the time information of the electronic device 100 itself or the location information of the electronic device 100 when capturing an image. In most cases, users do not classify a large number of images in their electronic devices (e.g., smartphones). However, if a user wants to search for a specific image, he or she may only sort by time or location information to find the desired image, and it is difficult to quickly obtain the desired image.

The embodiment of the present disclosure provides a technology for searching images, allowing users to use the text description of the image (such as the “search string” described in this embodiment) and combine with a plurality of artificial intelligence (AI) models (such as classification AI models, image and text multi-modal AI model, natural language recognition model, etc.) and corresponding databases to more accurately find the required image from a large number of images.

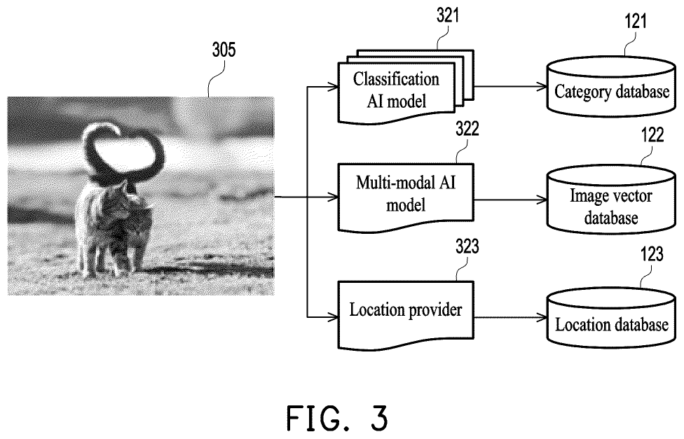

FIG. 2 is a first flowchart of a method for image search according to an embodiment of the present disclosure. FIG. 3 is a schematic diagram of a plurality of AI models and corresponding databases in FIG. 2. FIG. 2 is provided to first process the to-be-searched image stored in the storage device 120, so that the image search may be carried out more effectively and smoothly. Each step in FIG. 2 may be implemented by the electronic device 100 in FIG. 1. In FIG. 3, a plurality of models (e.g., classification AI model 321, multi-modal AI model 322), a location provider 323, and a plurality of databases (e.g., category database 121, image vector database 122, and location database 123) may be implemented through software and may be stored in the storage device 120 in FIG. 1.

Please refer to FIG. 1, FIG. 2 and FIG. 3 at the same time. In step S210 of FIG. 2, the processor 110 obtains the aforementioned to-be-searched image. The “to-be-searched image” in this embodiment may have location information due to the functions of the camera or mobile phone, or may not have location information. “To-be-searched image” may also have a classification tag before performing each step in FIG. 2 of this embodiment. This classification tag may be marked by the user, or may be automatically marked due to the function of the camera or mobile phone.

In step S215 of FIG. 2, the processor 110 determines whether the to-be-searched image has a corresponding geographical location. If step S215 in FIG. 2 is YES, then step S220 in FIG. 2 is carried out.

In step S220 of FIG. 2, when the to-be-searched image has a corresponding geographical location, the processor 110 uses the location provider 323 to obtain the corresponding first geographical information based on the geographical location information corresponding to the to-be-searched image (such as the image 305 in FIG. 3), and stores the first geographical information and the corresponding relationship between the to-be-searched image and the first geographical information in the location database 123. Specifically, when capturing an image, the image (e.g., to-be-searched image) may be matched with the geographical location information (e.g., GPS longitude and latitude coordinates) of the electronic device 100 itself, and the aforementioned geographical location information may even be stored in the image. The processor 110 of FIG. 1 uses the location provider 323 to query and obtain the corresponding first geographical information based on the geographical location information (GPS latitude and longitude coordinates) corresponding to each to-be-searched image.

The location provider 323 is a hardware, software or firmware device that may convert GPS longitude and latitude coordinates into specific geographical information. The location provider 323 in this embodiment is implemented in the form of software of an application programming interface (API), and the corresponding textual geographical information (such as California, USA, Hsinchu City, Taiwan, etc.) may be generated by inputting GPS latitude and longitude coordinates. The location database 123 may store location-related information of all to-be-searched images, including but not limited to:

GPS longitude and latitude, countries, cities, administrative districts at all levels, street names, landmarks and other information.

“To-be-searched image” may have corresponding classification tags. These classification tags may be marked by users themselves, or the “classification AI model” may classify “to-be-searched image” and generate corresponding classifications tags. Specifically, the “classification AI model” in this embodiment may be implemented by a convolutional neural network (CNN) model or CNN algorithm. Those who apply this embodiment may adopt different classification AI models correspondingly to classify a large number of to-be-searched images stored in the storage device 120 into different categories according to their needs. For example, the classification AI model may identify that the image contains a cat, a tail and/or a grassland based on the content in an image (for example, image 305 in FIG. 3), and consider these identified contents as the “classification tag” described in this embodiment, and store these classification tags in the aforementioned images, or make these classification tags correspond to the aforementioned image.

In step S230 of FIG. 2, when the to-be-searched image has a corresponding classification tag, the processor 110 generates at least one classification tag corresponding to the aforementioned to-be-searched image based on the to-be-searched image according to the classification AI model, and stores the classification tag and the corresponding relationship between the to-be-searched image and the classification tag in the category database 121.

This embodiment may use a variety of classification AI models to classify these to-be-searched images and generate corresponding classification tags in step S230 of FIG. 2, and store these to-be-searched images and classification tags in the category database 121 of FIG. 3, so as to diversify the relationship between the aforementioned classification tag and images. The category database 121 may store classification tag information corresponding to all to-be-searched images.

“To-be-searched image” may not have the aforementioned classification tag, and those who apply the embodiment may adaptively make the to-be-searched image to not to proceed step S230 in FIG. 2 according to the needs of those who apply the embodiment as well as the content of the to-be-searched image, so the classification AI model is not utilized to generate the classification tag corresponding to the to-be-searched image.

In step S240 of FIG. 2, the processor 110 obtains the first comparison vector corresponding to each to-be-searched image based on each to-be-searched image according to the multi-modal AI model, and stores the first comparison vector and the corresponding relationship between the to-be-searched image and the first comparison vector in the image vector database 122. In detail, the “multi-modal AI model” in this embodiment is a machine learning model that is able to process images and text simultaneously. The “multi-modal AI model” may be used to understand the relationship between images and text, and consists of two parts: an image model and a text model. The image model may extract features from images and encode the features into image vectors. The text model may extract features from text or strings and encode the features into text vectors. The multi-modal AI model in this embodiment may be implemented through a Contrastive Language-Image Pre-Training (CLIP) model or a CLIP algorithm.

The multi-modal AI model in step S240 utilizes each to-be-searched image to extract the feature code to generate an image vector corresponding to this to-be-searched image, and this image vector is regarded as the first comparison vector. The image vector database 122 may store image vectors (first comparison vectors) and corresponding information of all to-be-searched images.

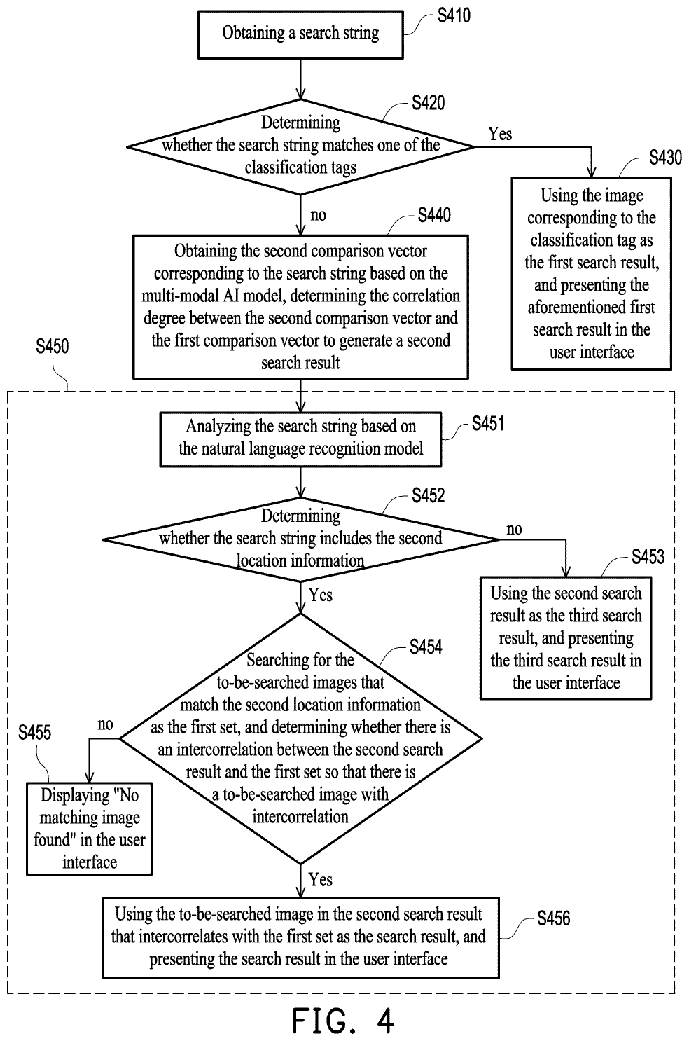

FIG. 2 shows the steps S210 to S240 performed when the user takes a photo or downloads a new picture from a source such as a social networking website through the electronic device 100 of FIG. 1 to prepare for each step in the method for image search in FIG. 4. FIG. 4 is a second flowchart of a method for image search according to an embodiment of the present disclosure. In this embodiment, each to-be-searched image will have a corresponding comparison vector, and these comparison vectors are stored in the image vector database 122 in FIG. 3. Each classification tag in the category database 121 in FIG. 3 corresponds to a part of the to-be-searched image respectively. Each location information in the location database 123 in FIG. 3 corresponds to a part of the to-be-searched images respectively.

Referring to FIG. 1 and FIG. 4, in step S410, the user inputs a search string corresponding to the image description that he or she wants to search through the input device of the electronic device 100, so that the processor 110 obtains the aforementioned search string. In other words, the search string is provided to search for one or more of a plurality of to-be-searched images. Examples of search text are “a white dog running on the grassland”, “a child holding a cat”, “photos of skiing in Japan”. . . etc. As can be seen from FIG. 2, each to-be-searched image corresponds to at least one classification tag, a first comparison vector (such as an icon vector) and the first location information.

In step S420, the processor 110 determines whether the aforementioned search string completely matches one of the aforementioned classification tags. If step S420 is yes, it means that the search string (e.g., “cat”, “grassland”) matches one of the aforementioned classification tags. Therefore, after step S420, step S430 is carried out, and the processor 110 generates a first search result based on the to-be-searched image corresponding to one of the aforementioned classification tags, and presents the aforementioned first search result in the user interface.

In contrast, if the result in step S420 is negative, step S440 is performed following step S420. The processor 110 obtains the second comparison vector corresponding to the search string based on the aforementioned “multi-modal AI model”, determines the correlation degree between the second comparison vector and the first comparison vectors corresponding to the plurality of to-be-searched images to generate a second search result. The second search result includes some of the images in the to-be-searched image, and the correlation degree between the first comparison vector and the second comparison vector of these images is higher than the preset threshold. Specifically, the text model in the multi-modal AI model extracts the feature code in the aforementioned search string into a text vector, and this text vector serves as the aforementioned second comparison vector. The processor 110 calculates the cosine similarity between the second comparison vector (text vector) corresponding to the search string and the first comparison vector corresponding to the to-be-searched image, and compares the cosine similarity with the value of the preset threshold to determine the correlation degree between the second comparison vector and the first comparison vector corresponding to each to-be-searched image.

When the cosine similarity is greater than the preset threshold, it means that the search string has a higher correlation degree with the corresponding to-be-searched image, and the processor 110 may use this to-be-searched image as one of several images in the second search result. When the cosine similarity is less than the preset threshold, it means that the search string has a low correlation degree with the corresponding to-be-searched image, and therefore the to-be-searched image will not be used as a search result. Those who apply this embodiment may find one or more to-be-searched images as second search results according to the aforementioned correlation degree, and may sort the images in the second search results according to the correlation degree.

In step S450, the processor 110 identifies whether the aforementioned search string has second location information, generates a third search result based on the second search result and the second location information in step S440, and presents the aforementioned third search result in the user interface 140 in FIG. 1. Step S450 in this embodiment may include steps S451 to S456, which are described in detail here.

In step S451, the processor 110 analyzes the aforementioned search string based on the natural language recognition model. Thus, in step S452, the processor 110 determines whether the search string includes the second location information. “Natural language recognition (NER) model” is a machine learning model that is able to identify and classify named entities in natural language texts, sentences, and strings. The aforementioned named entities may be person names, place names, organization names, dates, times, numbers, etc., which may be adjusted according to the needs of the user. In this embodiment, the “natural language recognition (NER) model” may be implemented through a Bidirectional Encoder Representations from Transformers (BERT) model or BERT algorithm, and the aforementioned named entity may be an entity selected from a place name, a geographical description or a related meaning.

When the result of step S452 is negative, it means that the search string does not contain any location information, then step S453 is performed following step S452. The processor 110 uses the second search result in step S440 as the third search result, and presents the third search result in the user interface. In contrast, when step S452 is yes, it means that the search string contains location information (which is regarded as the second location information), then step S454 is performed following step S452. The processor 110 searches for all to-be-searched images that match the second location information (that is, the corresponding images taken in the second location information) from the location database 123 in FIG. 3 as the first set, and determines whether there is an intercorrelation between the aforementioned second search result and the first set so that there is a to-be-searched image with intercorrelation.

The to-be-searched image in the aforementioned second search result that intercorrelates with the first set is used as the third search result.

If there is no image in the second search result that intercorrelates with the first set, step S455 is carried out following step S454, and the processor 110 displays “No matching image found” in the user interface. On the other hand, if there is a to-be-searched image in the second search result that intercorrelates with the first set, then step S456 is performed following step S454, and the processor 110 uses the to-be-searched image in the second search result that intercorrelates with the first set as the third search result, and presents the third search result in the user interface.

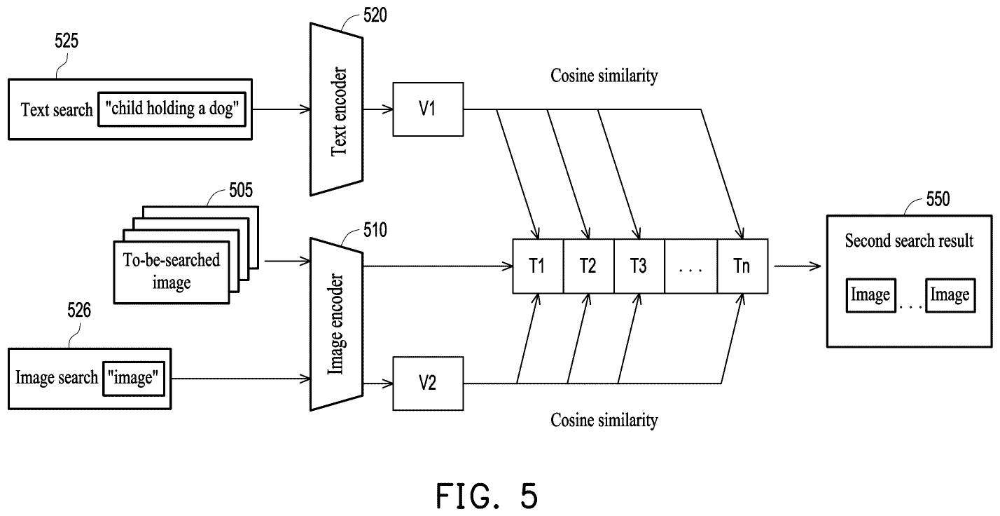

FIG. 5 is a schematic diagram of a multi-modal AI model for images and text according to an embodiment of the present disclosure. In this embodiment, the multi-modal AI model for images and text is mainly divided into an image model and a text model. The image model is mainly based on the image encoder 510 in FIG. 5. The image encoder 510 in this embodiment extracts feature codes from a plurality of to-be-searched images 505 to generate image vectors such as image vectors T1˜Tn corresponding to various to-be-searched images 505. Those who apply this embodiment may utilize the search string 525 (for example, “child holding a dog”) obtained from step S410 in FIG. 4 to have the text encoder 520 extract the feature code from the search string 525 to generate a text vector V1, and compare the cosine similarity between the vector V1 and the image vectors T1˜Tn and use the cosine similarity as the correlation degree between the two, so that the second search result 550 in step S440 of FIG. 4 is obtained through the cosine similarity and the preset threshold.

Those who apply this embodiment may also use the image retrieval 526 in FIG. 5 to allow the image encoder 510 to extract feature codes from the images in the image retrieval 526 to generate the image vector V2 corresponding to the image, and compare the cosine similarity between the image vector V2 and the image vectors T1˜Tn and use the cosine similarity as the correlation degree between the two, so that the search results of image search by using images are obtained through the cosine similarity and the preset threshold.

To sum up, the method and electronic device for image search described in the embodiments of the present disclosure first generate one or more classification tags, comparison tags and location information corresponding to each to-be-searched image for a large number of to-be-searched images through a classification AI model, a multi-modal AI model and a location provider. Then, it is determined based on the search string input by the user whether the classification tag is one of the classification tags in the category database. If the search string is one of the classification tags, the to-be-searched image corresponding to the classification tag will be used as the search result and presented in the user interface. In contrast, if the search string does not completely match one of the classification tags, the embodiment uses the multi-modal AI model to compare the correlation degree between the comparison vector of the search string and the comparison vector corresponding to each to-be-searched image, and uses the natural language recognition model to analyze the location information in the search string to use the to-be-searched image that is highly relevant and located in the corresponding location information as a search result and present the to-be-searched image in the user interface. Through the method and electronic device in the embodiments of the present disclosure, users may more conveniently find the desired images or photos among a large number of images.

What is claimed is:

1. A method for image search, comprising:
obtaining a search string, wherein the search string is provided to search for one or more of a plurality of to-be-searched images, each of the to-be-searched images corresponds to a first comparison vector, and at least one classification tag and first location information respectively correspond to a part of the to-be-searched images;
determining whether the search string matches one of the at least one classification tag, and while the search string matches the one of the at least one classification tag, generating a first search result based on the to-be-searched image corresponding to the one of the at least one classification tag, and presenting the first search result in a user interface;
wherein while the search string does not match the one of the at least one classification tag, obtaining a second comparison vector corresponding to the search string according to the search string based on a multi-modal artificial intelligence (AI) model, determining a correlation degree between the second comparison vector and the at least one first comparison vector corresponding to the to-be-searched image to generate a second search result, wherein the second search result comprises a part of the to-be-searched images; and
identifying whether the search string has second location information, so that a third search result is generated based on the second search result and the second location information, and the third search result is presented in the user interface.

2. The method according to claim 1, further comprising:
querying and obtaining corresponding first geographical information based on geographical location information corresponding to the to-be-searched image, and storing the first geographical information and a corresponding relationship between the to-be-searched image and the first geographical information in a location database;
generating the at least one classification tag corresponding to the to-be-searched image based on the to-be-searched image according to a classification AI model, and storing the at least one classification tag and a corresponding relationship between the to-be-searched image and the at least one classification tag in a category database; and
obtaining the at least one first comparison vector corresponding to each of the to-be-searched images based on each of the to-be-searched images according to the multi-modal AI model, and storing the at least one first comparison vector and a corresponding relationship between the to-be-searched image and the at least one first comparison vector in an image vector database.

3. The method according to claim 1, wherein the multi-modal AI model is a multi-modal AI model for images and text.

4. The method according to claim 1, wherein the step of identifying whether the search string has the second location information so that the third search result is generated based on the second search result and the second location information comprises:
analyzing the search string based on a natural language recognition model to determine whether the search string comprises the second location information, determining whether the second location information matches the first location information;
wherein when the second location information does not match the first location information, using the second search result as the third search result; and
wherein when the second location information matches the first location information, using the to-be-searched image in the second search result that matches the first location information as the third search result.

5. The method according to claim 1, wherein the step of determining the correlation degree between the second comparison vector and the at least one first comparison vector corresponding to the to-be-searched image comprises:
calculating a cosine similarity between the second comparison vector and the at least one first comparison vector corresponding to the to-be-searched image; and
comparing the cosine similarity with a preset threshold to determine the correlation degree between the second comparison vector and the at least one first comparison vector corresponding to the to-be-searched image.

6. The method according to claim 1, wherein a natural language recognition model is utilized to identify whether the search string has the second location information.

7. The method according to claim 1, wherein the first search result is the to-be-searched image corresponding to the one of the at least one classification tag that the search string matches.

8. An electronic device, comprising:
a processor;
a storage device provided to store a plurality of to-be-searched images; and
a display device comprising a user interface,
wherein the processor obtains a search string, wherein the search string is provided to search for one or more of the plurality of to-be-searched images, each of the to-be-searched image corresponds to a first comparison vector, and at least one classification tag and first location information respectively correspond to a part of the to-be-searched image,
the processor determines whether the search string matches one of the at least one classification tag, and while the search string matches the one of the at least one classification tag, generates a first search result based on the to-be-searched image corresponding to the one of the at least one classification tag, and presents the first search result in the user interface,
wherein while the search string does not match the one of the at least one classification tag, the processor obtains a second comparison vector corresponding to the search string according to the search string based on a multi-modal artificial intelligence (AI) model, determines a correlation degree between the second comparison vector and the at least one first comparison vector corresponding to the to-be-searched image to generate a second search result, wherein the second search result comprises a part of the to-be-searched images,
the processor identifies whether the search string has second location information, so that a third search result is generated based on the second search result and the second location information, and the third search result is presented in the user interface.

9. The electronic device according to claim 8, wherein the processor queries and obtains corresponding first geographical information based on geographical location information corresponding to the to-be-searched image, and stores the first geographical information and a corresponding relationship between the to-be-searched image and the first geographical information in a location database,
the processor generates the at least one classification tag corresponding to the to-be-searched image based on the to-be-searched image according to a classification AI model, and stores the at least one classification tag and a corresponding relationship between the to-be-searched image and the at least one classification tag in a category database, and
the processor obtains the at least one first comparison vector corresponding to each of the to-be-searched images based on each of the to-be-searched images according to the multi-modal AI model, and stores the at least one first comparison vector and a corresponding relationship between the to-be-searched image and the at least one first comparison vector in an image vector database.

10. The electronic device according to claim 8, wherein the multi-modal AI model is a multi-modal AI model for images and text.

11. The electronic device according to claim 8, wherein the processor analyzes the search string based on a natural language recognition model to determine whether the search string comprises the second location information, and the processor determines whether the second location information matches the first location information,
wherein when the second location information does not match the first location information, the processor uses the second search result as the third search result,
wherein when the second location information matches the first location information, the processor uses the to-be-searched image in the second search result that matches the first location information as the third search result.

12. The electronic device according to claim 8, wherein the processor calculates a cosine similarity between the second comparison vector and the at least one first comparison vector corresponding to the to-be-searched image, and compares the cosine similarity with a preset threshold to determine the correlation degree between the second comparison vector and the at least one first comparison vector corresponding to the to-be-searched image.

13. The electronic device according to claim 8, wherein the processor adopts a natural language recognition model to identify whether the search string has the second location information.

14. The electronic device according to claim 8, wherein the first search result is the to-be-searched image corresponding to the one of the at least one classification tag that the search string matches.
